(19) United States
(12) Patent Application Publication
(10) Pub. No.: US 2025/0219546 A1
(43) Pub. Date: Jul. 3, 2025

(54) FLYBACK SWITCHING POWER SUPPLY, SELF-POWERED CIRCUIT AND METHOD THEREOF

(71) Applicant: LII SEMICONDUCTOR CO., LTD, Shenzhen (CN)

(72) Inventors: Xinchun LIN, Shenzhen (CN); Lingbo ZHENG, Shenzhen (CN); Fulong WANG, Shenzhen (CN); Jie ZHANG, Shenzhen (CN)

(73) Assignee: LII SEMICONDUCTOR CO., LTD, Shenzhen (CN)

(21) Appl. No.: 19/084,045

(22) Filed: Mar. 19, 2025

Related U.S. Application Data
(63) Continuation of application No. PCT/CN2023/097189, filed on May 30, 2023.

(30) Foreign Application Priority Data
Oct. 27, 2022 (CN) 202211329091.4

(51) Int. Cl. H02M 3/335

(52) U.S. Cl. CPC H02M 3/3353; H02M 3/33515

(57) ABSTRACT

Disclosed are a flyback switching power supply and a self-powered circuit and method therefor. The self-powered circuit includes: a charging capacitor configured to draw power from a primary coil and supply power to a switching power supply chip; a withstand voltage switch tube for acquiring a power supply voltage of the primary coil and outputting a charging voltage; a charging switch tube for controlling whether to charge the charging capacitor; an adjustment control tube for limiting the charging voltage of the charging capacitor; a voltage limiting control unit for controlling the conduction state of the adjustment control tube according to the charging voltage; a charging control unit preset with a charging requirement; and an inverter for acquiring the conduction switch signal and controlling the voltage limiting control unit or the charging control unit to be connected to the adjustment control tube according to the conduction switch signal.

### CROSS-REFERENCE TO RELATED APPLICATIONS

This application is a continuation application of International Application No. PCT/CN2023/097189, filed on May 30, 2023, which claims priority to Chinese Patent Application No. 202211329091.4, filed on Oct. 27, 2022. The disclosures of the above-mentioned applications are incorporated herein by reference in their entireties.

### TECHNICAL FIELD

The present application relates to the field of switching power supply control, and in particular to a flyback switching power supply, a self-powered circuit and method thereof.

### BACKGROUND

As a kind of power conversion equipment, the flyback switching power supply uses the switching power supply chip to control the switch tube to turn on and off, so as to achieve the energy conversion output of the switch. Its working mode is usually divided into continuous conduction mode (CCM) and discontinuous conduction mode (DCM). The difference between the two is whether the current in the coil is reduced to 0 in each cycle. For the DCM, the coil current is reduced to 0 in each switching cycle, so when each new cycle comes, the coil current starts to rise from 0. For the CCM, when the coil current has not yet been reduced to 0 in each switching cycle, the next switching cycle has arrived, so when each new cycle comes, the coil current starts to rise from a certain value (non-zero value).

With the diversification of electronic devices, power supply technology has achieved unprecedented development. The switching speed is getting faster and faster, the power is getting bigger and bigger, but the chip area is getting smaller and smaller. This puts higher requirements on the development indicators of switching power supply control technology. The switching power supply chip itself also needs to consume energy, so it is necessary to set up a self-powered circuit to power the switching power supply chip. Since the switching power supply has two working modes, CCM and DCM, the existing switching power supply self-powered circuit is usually designed according to the working mode of the switching power supply. However, the working mode of the switching power supply is determined by the load. In actual use, the switching power supply may experience working mode jumps. When the working mode of the switching power supply changes, if the original self-powered circuit is designed according to DCM mode, it is difficult for the self-powered circuit to achieve low current charging due to the working characteristics of CCM mode.

### SUMMARY

In order to ensure that the charging capacitor can be charged with a small current when the switching power supply operates in a continuous mode or a discontinuous mode, the present application provides a flyback switching power supply and a self-powered circuit and method thereof.

In a first aspect, the present application provides a self-powered circuit of a flyback switching power supply, which adopts the following technical solution.

A self-powered circuit of a flyback switching power supply, which is applied to the flyback switching power supply, includes: a charging capacitor, a withstand voltage switch tube, a charging switch tube, an adjustment control tube, a voltage limiting control unit, a charging control unit, and an inverter.

The charging capacitor is configured to draw power from the primary coil and supply power to the switching power supply chip.

The withstand voltage switch tube is connected between the primary coil and the charging capacitor, configured to obtain a power supply voltage of the primary coil, and output a charging voltage for charging the charging capacitor.

The charging switch tube is connected between the withstand voltage switch tube and the charging capacitor, and the charging switch tube is provided with a control electrode coupled to the switching power supply chip for controlling whether to charge the charging capacitor.

The adjustment control tube is connected between the withstand voltage switch tube and the ground, connected in parallel with the charging switch tube and the charging capacitor, and configured to limit the charging voltage of the charging capacitor.

An input terminal of the voltage limiting control unit is coupled to the withstand voltage switch tube and is configured to sample the charging voltage, and an output terminal of the voltage limiting control unit is coupled to the control electrode of the adjustment control tube and configured to control conduction state of the adjustment control tube according to the charging voltage.

The charging control unit is preset with a charging requirement and configured to output a conduction switch signal for controlling the adjustment control tube to be turned on or off.

The inverter is coupled to the voltage limiting control unit and the charging control unit, and configured to obtain the conduction switch signal, and control the voltage limiting control unit or the charging control unit to be connected to the adjustment control tube according to the conduction switch signal.

By adopting the above technical solution, the high-voltage resistance performance of the withstand voltage switch tube enables the charging capacitor to be connected to the primary coil, so that the charging capacitor draws power from the primary coil, thereby ensuring that the charging of the charging capacitor is not affected by the load. The charging voltage of the charging capacitor is detected by setting a voltage limiting control unit and the charging voltage of the charging capacitor is kept at a low voltage by controlling the adjustment control tube, thereby ensuring that the charging capacitor is charged with a small current. The conduction of the adjustment control tube is controlled by the charging control unit to ensure the energy storage of the primary coil. At the same time, by setting up an inverter, it ensures that the adjustment control tube cannot be controlled by both the charging control unit and the voltage limiting control unit under the action of the inverter at the same time, thereby ensuring that the charging capacitor recharging and the primary coil energy storage will not affect each other, which will cause the switching power supply to fail to operate normally.

In a second aspect, the present application provides a switching power supply applying the self-powered circuit of the above-mentioned flyback switching power supply, which adopts the following technical solution.

A switching power supply applying the self-powered circuit of the above-mentioned flyback switching power supply includes a transformer, an output control module configured to adjust a load regulation rate, and a self-powered circuit configured to supply power to the output control module.

The transformer comprises a primary coil and a secondary coil.

The output control module comprises a switching power supply chip configured to outputting a control signal.

The self-powered circuit includes a charging capacitor configured to power, a charging switch tube and a charging control unit configured to control whether the charging capacitor is charged, and a voltage limiting control unit configured to limit charging voltage of the charging capacitor.

In a third aspect, the present application provides a self-powering method of a self-powered circuit based on the above-mentioned flyback switching power supply, which adopts the following technical solution.

A self-powering method of a self-powered circuit based on the above-mentioned flyback switching power supply includes the following steps:
acquiring a control signal of a switching power supply chip;
determining whether the control signal is a high-level signal; in response to that the control signal is the high-level signal, performing the following steps; in response to that the control signal is not the high-level signal, reacquiring the control signal;
determining whether a charging circuit is turned on; in response to that the charging circuit is turned on, charging a charging capacitor and performing the following steps; in response to that the charging circuit is not turned on, stopping charging the charging capacitor; and
obtaining a charging voltage and determining whether the charging voltage is greater than a preset voltage value; in response to that the charging voltage is greater than the preset voltage value, making a voltage analog signal greater than the adjustment control tube turn-on value to pull down the charging voltage; in response to that the charging voltage is not greater than the preset voltage value, making the voltage analog signal a low-level signal.

Furthermore, the determining whether the charging circuit is turned on includes the following steps:
determining whether a conduction time of the charging circuit reaches a preset time; in response to that the conduction time of the charging circuit does not reach the preset time, turning on the charging circuit; in response to that the conduction time of the charging circuit reaches the preset time, turning off the charging circuit.

Furthermore, the determining whether the charging circuit is turned on includes the following steps:
determining whether a voltage signal of the charging capacitor is less than a first reference signal; in response to that the voltage signal of the charging capacitor is less than the first reference signal, recharging the charging capacitor and performing the following steps; in response to that the voltage signal of the charging capacitor is not less than the first reference signal, do not recharging the charging capacitor;
determining whether the conduction time of the charging circuit reaches the preset time; and
determining whether the voltage signal of the charging capacitor is greater than a second reference signal.

In response to that the conduction time of the charging circuit does not reach the preset time and the voltage signal of the charging capacitor is less than or equal to the second reference signal, turning on the charging circuit; in response to that the conduction time of the charging circuit reaches the preset time or the voltage signal of the charging capacitor is greater than a second reference signal, turning off the charging circuit.

### BRIEF DESCRIPTION OF THE DRAWINGS

FIG. 1 is a schematic diagram of a partial circuit structure of a flyback switching power supply according to an embodiment of the present application.

FIG. 2 is a schematic diagram of a self-powered circuit structure of a flyback switching power supply according to an embodiment of the present application, mainly showing a specific circuit structure of a charging control unit as a delay device.

FIG. 3 is a waveform diagram of a flyback switching power supply according to an embodiment of the present application, mainly showing a waveform diagram when the charging control unit is a delay device.

FIG. 4 is a schematic diagram of a self-powered circuit structure of a flyback switching power supply according to an embodiment of the present application, mainly showing a circuit block diagram of a charging control unit as a delay device and a voltage sampler.

FIG. 5 is a schematic diagram of a self-powered circuit structure of a flyback switching power supply according to an embodiment of the present application, mainly showing a specific circuit structure of a charging control unit as a delay device and a voltage sampler.

FIG. 6 is a waveform diagram of a flyback switching power supply according to an embodiment of the present application, mainly showing a waveform diagram when the charging control unit is a delay device and a voltage sampler.

FIG. 7 is a flowchart of a self-powering method of a flyback switching power supply according to an embodiment of the present application.

FIG. 8 is a partial flowchart of a self-power supply method of a flyback switching power supply according to an embodiment of the present application, mainly showing a flow chart when a charging requirement is charging time.

FIG. 9 is a partial flowchart of a self-power supply method of a flyback switching power supply according to an embodiment of the present application, mainly showing a flow chart when a charging requirements are a charging time and a charging voltage of a charging capacitor.

### DETAILED DESCRIPTION OF AN EMBODIMENTS

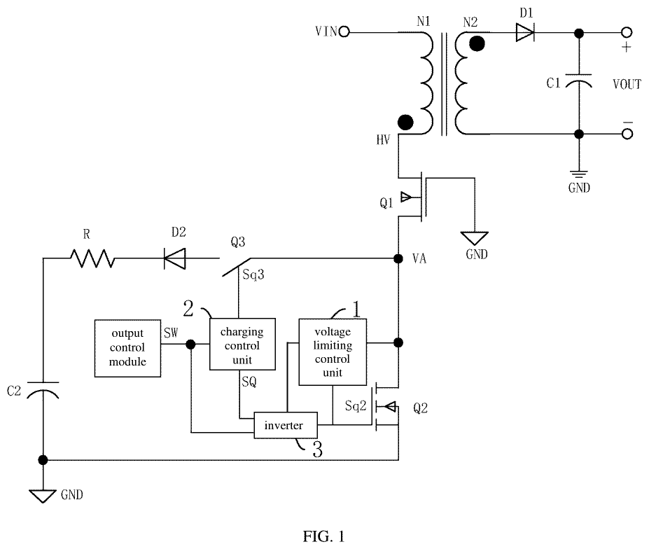

The present application is further described in detail below in conjunction with the drawings FIG. 1 to FIG. 9.

An embodiment of the present application discloses a flyback switching power supply. As shown in FIG. 1, the switching power supply includes a transformer, an output control module for improving the load regulation rate, and a self-powered circuit for powering the output control module. The transformer includes a primary coil N1, a secondary coil N2, and an output capacitor C1 connected in parallel to both ends of the secondary coil N2. Both ends of the output capacitor C1 are configured to connect the load. A unidirectional current limiting tube D1 is provided between the output capacitor C1 and the secondary coil N2, and the unidirectional current limiting tube D1 is a diode, whose anode is connected to the secondary coil N2, and whose cathode is connected to the non-inverting output terminal of the output capacitor C1, so as to prevent the output capacitor C1 from supplying power to the load while also supplying energy to the secondary coil N2. The primary coil N1 and the secondary coil N2 are mutually coupled and induced. When the primary coil N1 is turned on, the primary coil N1 stores energy, the secondary coil N2 does not work, and the output capacitor C1 supplies power to the load. One end of the primary coil N1 is configured to receive the power supply voltage VIN rectified by the rectifier, and the other end of the primary coil N1 is connected to the self-powered circuit. When the primary coil N1 is turned on, the self-powered circuit draws power from the primary coil N1. The output control module includes a switching power supply chip and its peripheral circuits. The switching power supply chip outputs a control signal SW for controlling the self-powered circuit to charge during the switching cycle of the switching power supply, and the control signal SW is also configured to adjust the output voltage of the switching power supply. In an embodiment of the present application, the control signal SW is a pulse width modulation (PWM) waveform signal.

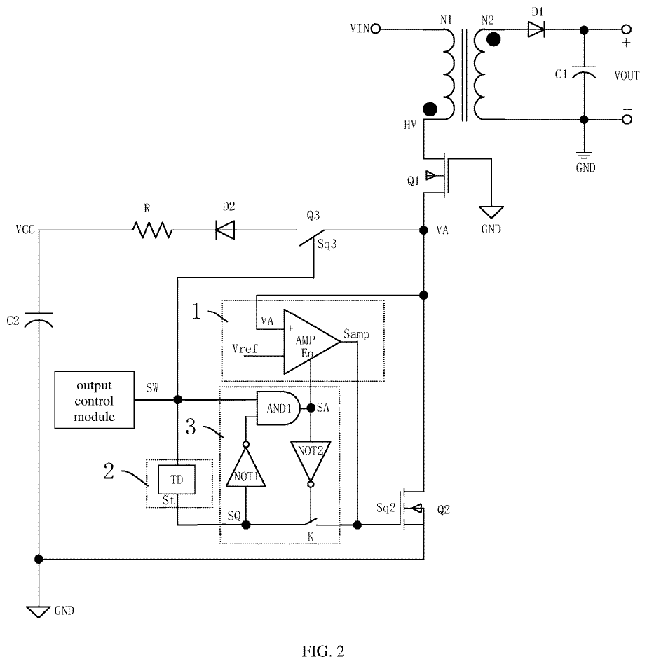

Referring to FIG. 1 and FIG. 2, the self-powered circuit includes a charging capacitor C2, a withstand voltage switch tube Q1, a charging switch tube Q3, an adjustment control tube Q2, a voltage limiting control unit 1 and a charging control unit 2.

The charging capacitor C2 is configured to draw power from the primary coil N1 and supply power to the switching power supply chip.

The withstand voltage switch tube Q1 is connected between the primary coil N1 and the charging capacitor C2, obtains the supply voltage of the primary coil N1, and outputs a charging voltage VA for charging the charging capacitor C2.

The charging switch tube Q3 is connected between the withstand voltage switch tube Q1 and the charging capacitor C2, and a control electrode of the charging switch tube Q3 is coupled to the switching power supply chip to control whether to charge the charging capacitor C2.

The adjustment control tube Q2 is connected between the withstand voltage switch tube Q1 and the ground, is connected in parallel with the charging switch tube Q3 and the charging capacitor C2, and is configured to limit the charging voltage VA of the charging capacitor C2.

An input terminal of the voltage limiting control unit 1 is coupled to the withstand voltage switch tube Q1 for sampling the charging voltage VA, and an output terminal of the voltage limiting control unit 1 is coupled to the control electrode of the adjustment control tube Q2 for controlling the conduction state of the adjustment control tube Q2 according to the charging voltage VA.

The charging control unit 2 is preset with a charging requirement and outputs a conduction switch signal SQ for controlling whether the adjustment control tube Q2 is turned on.

Specifically, referring to FIG. 1 and FIG. 2, the primary coil N1, the withstand voltage switch tube Q1, the charging switch tube Q3 and the charging capacitor C2 constitute a charging circuit for charging the charging capacitor C2. The primary coil N1, the withstand voltage switch tube Q1 and the adjustment control tube Q2 constitute a primary circuit, and when the adjustment control tube Q2 is turned on, the primary circuit is turned on. The control electrode of the charging switch tube Q3 is connected to the output terminal of the output control module and is controlled by the control signal SW output by the output control module. In an embodiment of the present application, when the control signal SW is at a high level, the charging switch tube Q3 is turned on. Therefore, in an embodiment of the present application, the charging switch tube Q3 is a high-level conduction switch tube, and the charging switch tube Q3 is not limited to metal-oxide-semiconductor field-effect transistor (MOS) tubes, triodes and other switch tubes. In an embodiment of the present application, the adjustment control tube Q2 is a high-level conduction switch tube, and the adjustment control tube Q2 adopts an N-channel MOS tube.

In order to reduce the complexity of the self-powered circuit, in an embodiment of the present application, the withstand voltage switch tube Q1 adopts a depletion-type gallium nitride transistor. Since the area of the device is related to the withstand voltage and the current flowing through the device, the higher the withstand voltage and the larger the current flowing through the device, the corresponding area of the device will also increase. The gallium nitride transistor is used as a high-voltage switch tube, and uses its working characteristics to take power from the source end to ensure that the chip only works in a low-voltage state, so as to meet the high withstand voltage requirements of the device, reduce the complexity of the device, and thus reduce the device area finally. The drain of the withstand voltage switch tube Q1 is connected to the primary coil N1, the gate of the withstand voltage switch tube Q1 is grounded, and the charging control unit 2 is connected in series between the source of the withstand voltage switch tube Q1 and the ground. In an embodiment of the present application, since the withstand voltage switch tube Q1 adopts a depletion-type gallium nitride transistor, it is in a conducting state under normal conditions. When the charging switch tube Q3 is turned on, whether the charging circuit is turned on is determined by whether the source of the withstand voltage switch tube Q1 is grounded.

The voltage limiting control unit 1 is preset with a voltage preset value Vref. When the charging voltage VA is greater than the voltage preset value Vref, the voltage limiting control unit 1 controls the adjustment control tube Q2 to start to pull down the charging voltage VA, so as to ensure that the charging voltage VA is less than or equal to the voltage preset value. When the control signal SW output by the switching power supply chip is at a high level, the charging switch tube Q3 is turned on, and the charging circuit is turned on at this time, and the charging capacitor C2 starts to charge. During the charging process of the charging capacitor C2, as the charging time increases, the charging voltage VA gradually increases, and the voltage limiting control unit 1 samples and detects the charging voltage VA of the charging circuit. When the voltage limiting control unit 1 detects that the charging voltage VA is greater than the preset voltage value Vref, the voltage limiting control unit 1 outputs a voltage analog signal Samp, and the voltage analog signal Samp is greater than the turn-on voltage of the adjustment control tube Q2 so that the adjustment control tube Q2 is turned on, and the charging voltage VA is pulled down. The voltage limiting control unit 1 is connected to the adjustment control tube Q2 to form a feedback loop, and finally the stable charging voltage VA is less than or equal to the voltage preset value Vref, so that the charging capacitor C2 is charged with a charging voltage VA less than the voltage preset value Vref.

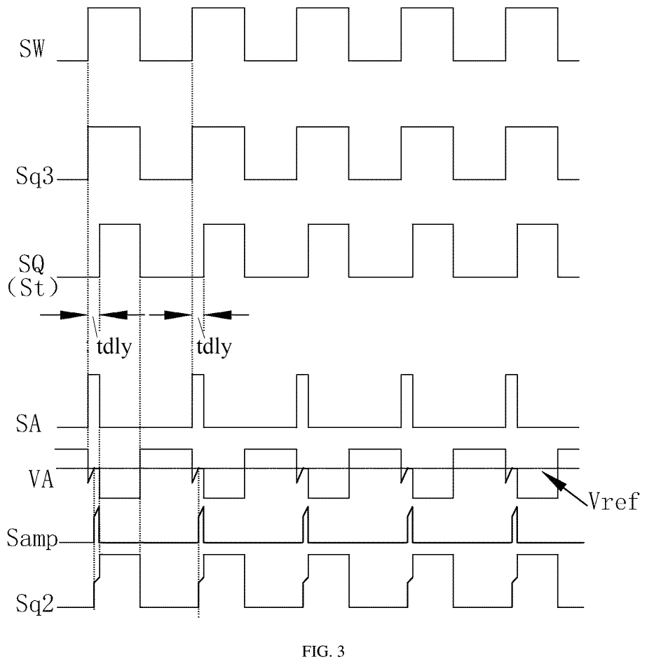

Specifically, referring to FIG. 2 and FIG. 3, the voltage limiting control unit 1 includes an operational amplifier AMP and a preset reference circuit. The preset reference circuit is coupled to an input terminal of the operational amplifier AMP, and is configured to provide a preset voltage value Vref. The other input terminal of the operational amplifier AMP is coupled to the source of the withstand voltage switch tube Q1 for obtaining the charging voltage VA, and the operational amplifier AMP compares the charging voltage VA with the preset voltage value Vref and outputs a voltage analog signal Samp according to the comparison result. The enable pin En of the operational amplifier is coupled to the output control module, and is configured to obtain the control signal SW. When a high-level signal is input to the enable pin En, the operational amplifier AMP works normally and outputs the voltage analog signal Samp, and when a high-level signal is input to the enable pin En, the operational amplifier AMP outputs a suspended state. In an embodiment of the present application, the preset reference circuit is connected to the inverting input terminal of the operational amplifier AMP, so that when the charging voltage VA is greater than the preset voltage value Vref, the voltage analog signal Samp output by the operational amplifier AMP is a positive value, and in an embodiment of the present application, the higher the charging voltage VA is relative to the preset voltage value Vref, the higher the voltage value of the voltage analog signal Samp output by the operational amplifier AMP.

Referring to FIG. 2 and FIG. 3, when a high-level signal is input to the enable pin En, if the charging voltage VA is less than the preset voltage value Vref, the voltage analog signal Samp output by the operational amplifier AMP is a low-level signal, the adjustment control tube Q2 remains cut off, the charging circuit is turned on, and the charging capacitor C2 is charged; if the charging voltage VA is greater than the preset voltage value Vref, the voltage analog signal Samp output by the operational amplifier AMP is a positive value and greater than the turn-on value of the adjustment control tube Q2, and the adjustment control tube Q2 is not fully turned on, is equivalent to an adjustable resistor, and divides the voltage so that the charging voltage VA decreases, and the operational amplifier AMP is connected to the adjustment control tube Q2 to form a negative feedback loop, so that when a high-level signal is input to the enable pin En, the charging voltage VA of the charging circuit remains less than or equal to the preset voltage value Vref, ensuring that the charging capacitor C2 is charged with a voltage less than the preset voltage value Vref. In an embodiment of the present application, the preset voltage value is set according to the operating voltage required by the switching power supply chip.

Referring to FIG. 2 and FIG. 3, in a normal state, when the control signal SW output by the switching power supply chip is at a high level, the primary coil N1 stores energy. When the charging circuit is turned on and the charging capacitor C2 is charged, although the primary coil N1 is also storing energy, the energy storage of the primary coil N1 is affected because the charging capacitor C2 is charging. To ensure that the primary coil N1 can store energy normally during the switching cycle, the charging control unit 2 is preset with a charging requirement. When the charging capacitor C2 meets the charging requirement, the charging control unit 2 outputs a high-level conduction switch signal SQ to turn on the adjustment control tube Q2. When the adjustment control tube Q2 is turned on, the source of the withstand voltage switch tube Q1 is pulled down to ground, and the source voltage of the withstand voltage switch tube Q1 is close to 0V. Therefore, the source voltage of the withstand voltage switch tube Q1 is lower than the voltage of the charging capacitor C2, the charging circuit is disconnected, and the charging capacitor C2 stops charging. At this time, the primary circuit is turned on, the primary coil N1 stores energy.

Referring to FIG. 2 and FIG. 3, in order to prevent the source voltage of the withstand voltage switch tube Q1 from being close to 0V when both the charging switch tube Q3 and the adjustment control tube Q2 are turned on, causing the charging capacitor C2 to discharge to the ground, a unidirectional conduction tube D2 is connected in series between the charging capacitor C2 and the charging switch tube Q3. When the current flows from the charging switch tube Q3 to the charging capacitor C2, the unidirectional conduction tube D2 is turned on; otherwise, the unidirectional conduction tube D2 is turned off. In an embodiment of the present application, the unidirectional conduction tube D2 adopts a diode, the anode of the diode is connected to the charging switch tube Q3, and the cathode of the diode is connected to the charging capacitor C2. In order to ensure the charging safety of the charging capacitor C2, a protection resistor R is also connected in series between the charging capacitor C2 and the charging switch tube Q3 to limit the charging current of the charging capacitor C2 and prevent the charging circuit from being short-circuited, so as to protect the charging capacitor C2.

Referring to FIG. 2 and FIG. 3, in order to prevent the charging control unit 2 and the voltage limiting control unit 1 from interfering with each other in controlling the adjustment control tube Q2, an inverter 3 is provided between the charging control unit 2 and the voltage limiting control unit 1. The inverter 3 includes a first AND gate AND1, a first NOT gate NOT1, a second NOT gate NOT2 and an output switch tube K.

An input terminal of the first NOT gate NOT1 is coupled to an output terminal of the charging control unit 2 and is configured to obtain a conduction switch signal SQ output by the charging control unit 2.

One input terminal of the first AND gate AND1 is connected to the output terminal of the first NOT gate NOT1, the other input terminal thereof is connected to the switching power supply chip, and the output terminal thereof is connected to the enable pin En of the operational amplifier AMP, for outputting an enable control signal SA. When the enable control signal SA output by the first AND gate AND1 is at a high level, the operational amplifier AMP works normally. When the enable control signal SA output by the first AND gate AND1 is at a low level, the output of the operational amplifier AMP is suspended.

The input terminal of the second NOT gate NOT2 is connected to the output terminal of the first AND gate AND1, and the output terminal thereof is coupled to the control electrode of the output switch tube K. The output switch tube K is a high-level conduction switch tube, which is not limited to MOS tubes, triodes and other switch tubes.

Specifically, referring to FIG. 2 and FIG. 3, when the control signal SW output by the switching power supply chip is at a high level, the charging switch tube Q3 is turned on. At this time, if the conduction switch signal SQ output by the charging control unit 2 is at a low level, the conduction switch signal SQ is converted to a high level by the first NOT gate NOT1. Both input terminals of the first AND gate AND1 are high-level input terminals, and the enable control signal SA output by the first AND gate AND1 is at a high level, so that the operational amplifier AMP works normally. The high-level signal output by the first AND gate AND1 is converted to a low-level signal again by the second NOT gate NOT2, so that the output switch tube K is turned off, and the control electrode of the adjustment control tube Q2 is controlled by the voltage analog signal Samp output by the operational amplifier AMP, the charging circuit remains turned on, and the charging capacitor C2 is continuously charged.

Referring to FIG. 2 and FIG. 3, if the conduction switch signal SQ output by the charging control unit 2 is high level, the conduction switch signal SQ is converted to low level by the first NOT gate NOT1. At this time, since one input terminal of the first NOT gate NOT1 is a low-level input terminal, the enable control signal SA output by the first AND gate AND1 is a low-level signal, and the operational amplifier AMP is suspended. The low-level signal output by the first AND gate AND1 is converted to a high-level signal again by the second NOT gate NOT2, so the output switch tube K is turned on, and the control electrode of the adjustment control tube Q2 is controlled by the conduction switch signal SQ of the charging control unit 2. Since the conduction switch signal SQ is a high-level signal, the adjustment control tube Q2 is turned on, and the source of the withstand voltage switch tube Q1 is pulled down to ground, and the source voltage of the withstand voltage switch tube Q1 is close to 0V, so the source voltage of the withstand voltage switch tube Q1 is lower than the voltage of the charging capacitor C2, the charging circuit is disconnected, and the charging capacitor C2 stops charging. At this time, the primary circuit is turned on and the primary coil N1 stores energy.

Referring to FIG. 2 and FIG. 3, in order to ensure that the charging capacitor C2 has enough time to charge, the charging control module includes a delay device TD, which is provided with a preset time Tdly, coupled between the adjustment control tube Q2 and the switching power supply chip, and is configured to delay the output control signal SW. The preset time Tdly is a time on the order of hundreds of nanoseconds to ensure that the energy storage of the primary coil N1 of the switching power supply is not affected.

Specifically, the input terminal of the delay device TD is connected to the switching power supply chip, and the output terminal of the delay device TD is connected to the inverter 3 and is configured to output the delay signal St. In an embodiment of the present application, the delay signal St output by the delay device TD is the conduction switch signal SQ. The delay device TD is triggered by a high-level signal, that is, when the control signal SW is at a high level, the delay device TD starts timing, and within the preset time Tdly, the delay device TD still maintains a low-level output. At this time, the control electrode of the adjustment control tube Q2 is controlled by the voltage analog signal Samp output by the operational amplifier AMP, the charging circuit remains turned on, and the charging capacitor C2 continues to charge. When the timing duration reaches the preset time Tdly, the delay device TD outputs a high level, at this time, the control electrode of the adjustment control tube Q2 inputs a high-level signal, the adjustment control tube Q2 and the primary circuit are turned on.

When the charging circuit is turned on, the primary coil N1 also stores energy, but the energy storage speed of the primary coil N1 is slow. At the same time, as the charging circuit is turned on for an increasing time, the charging current of the charging circuit gradually increases. To ensure that the switching power supply can work normally and that the charging capacitor C2 can meet the power consumption requirements of the switching power supply chip, the preset time Tdly is set to the maximum while ensuring the normal operation of the switching power supply to ensure that the charging capacitor C2 has sufficient charging time.

The power supply principle of a self-powered circuit of a switching power supply in an embodiment of the present application is as follows: when the switching power supply chip outputs a high level, the charging switch tube Q3 is turned on, the charging circuit remains turned on, and the charging capacitor C2 is charged. Within the preset time Tdly, the delay signal St of the delay device TD is output at a low level. At this time, the control electrode of the adjustment control tube Q2 is controlled by the voltage limiting control unit 1. When the charging voltage VA of the charging capacitor C2 is lower than the preset voltage value Vref, the voltage analog signal Samp output by the operational amplifier AMP is a low-level signal, and the adjustment control tube Q2 does not pull down the charging voltage VA. When the charging voltage VA of the charging capacitor C2 is greater than the preset voltage value Vref, the voltage analog signal Samp output by the operational amplifier AMP is greater than the turn-on value of the adjustment control tube Q2, the adjustment control tube Q2 is in an incompletely turned-on state under the action of the voltage analog signal Samp, and the adjustment control tube Q2 pulls down the charging voltage VA, so that the charging voltage VA of the charging capacitor C2 is not greater than the preset voltage value Vref.

When the timing duration of the delay device TD reaches the preset time Tdly, the delay signal St output by the delay device TD is a high-level signal. At this time, the operational amplifier AMP is suspended, the control electrode of the adjustment control tube Q2 is controlled by the charging control unit 2, and the adjustment control tube Q2 is turned on. At this time, although the charging switch tube Q3 is also turned on, the source of the withstand voltage switch tube Q1 is grounded, so the charging capacitor C2 stops charging and the primary circuit is turned on to ensure that the primary coil N1 can store energy normally. When the control signal SW output by the switching power supply chip is low, the charging switch tube Q3 and the adjustment control tube Q2 are both turned off. At this time, the primary circuit is disconnected, and the secondary coil N2 supplies power to the load.

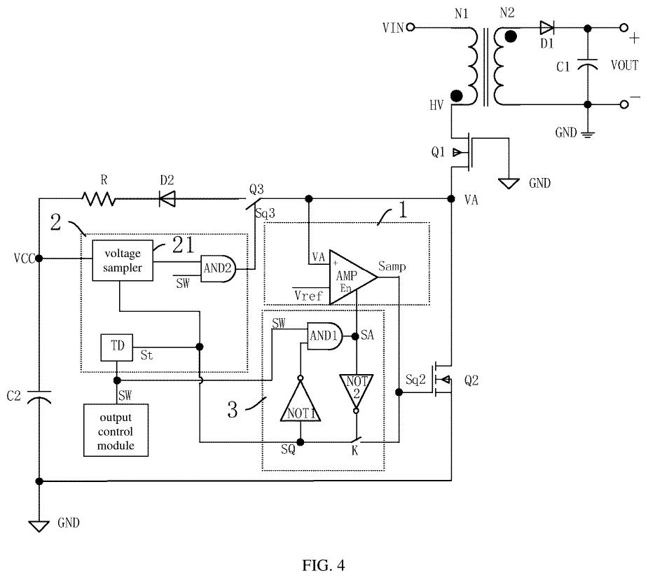

Further, in another embodiment, referring to FIG. 4, the charging control unit 2 further includes a voltage sampler 21 and a second AND gate AMD2.

The voltage sampler 21 is provided with an input terminal connected to one end of the charging capacitor C2, and configured to obtain the voltage signal VCC of the charging capacitor C2 and output a judgment signal S1; and an output terminal coupled to the control electrode of the adjustment control tube Q2. The voltage sampler 21 is configured to control whether the adjustment control tube Q2 is turned on or off.

The second AND gate AMD2 is provided with an input terminal respectively connected to the voltage sampler 21 and the switching power supply chip, and an output terminal connected to the control electrode of the charging switch tube Q3. The second AND gate AMD2 is configured to obtain the judgment signal S1 and the control signal SW, and control whether the charging switch tube Q3 is turned on according to the judgment signal S1 and the control signal SW.

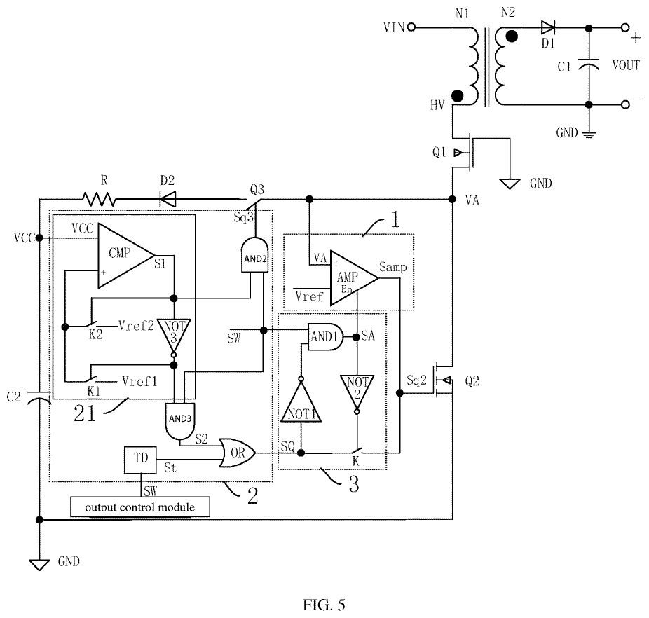

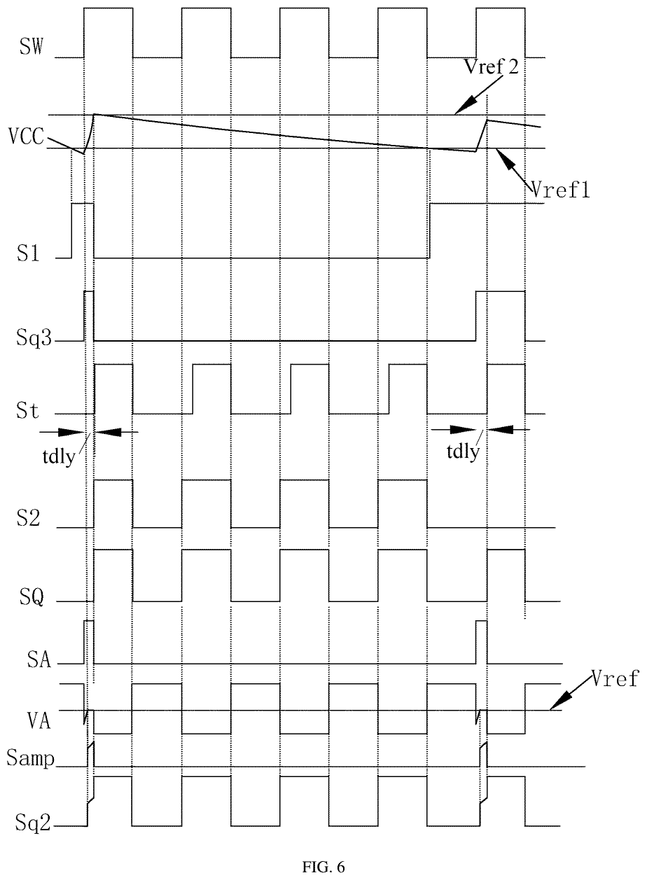

Specifically, referring to FIG. 5 and FIG. 6, in order to prevent the situation where the charging capacitor C2 is fully charged but the charging circuit remains turned on, the voltage sampler 21 is preset with a first reference signal Vref1 and a second reference signal Vref2. The voltage value of the first reference signal Vref1 is less than the voltage value of the second reference signal Vref2. When the voltage signal VCC of the charging capacitor C2 is lower than the first reference signal Vref1, it means that the charging capacitor C2 needs to be recharged. When the voltage signal VCC of the charging capacitor C2 is higher than the first reference signal Vref1, it means that the charging capacitor C2 does not need to be recharged. When the voltage signal VCC of the charging capacitor C2 is higher than the second reference signal Vref2, it means that the charging capacitor C2 has been fully recharged. When there is no voltage signal VCC of the charging capacitor C2 lower than the first reference signal Vref1 during the switching cycle, the voltage sampler 21 outputs a low-level signal, so the second AND gate AMD2 outputs a low-level signal. At this time, the charging switch tube Q3 is cut off and the charging circuit is not conducting. When there is a voltage signal VCC of the charging capacitor C2 lower than the first reference signal Vref1 during the switching cycle, the voltage sampler 21 outputs a high-level signal, so the output signal of the second AND gate AMD2 is controlled by the control signal SW of the switching power supply chip.

Specifically, the judgment signal S1 includes a recharging signal, a charging signal and a high-voltage signal. When the voltage signal VCC is lower than the first reference signal Vref1, the voltage sampler 21 outputs a recharging signal. When the voltage signal VCC is lower than the second reference signal Vref2, the voltage sampler 21 outputs a charging signal. When the voltage signal VCC is higher than the second reference signal Vref2, the voltage sampler 21 outputs a high-voltage signal. The voltage sampler 21 compares the voltage signal VCC with the first reference signal Vref1. When the voltage signal VCC is lower than the first reference signal Vref1, the voltage sampler 21 outputs a recharging signal. At the same time, the voltage sampler 21 compares the voltage signal VCC with the second reference signal Vref2. The voltage sampler 21 outputs a charging signal. When the voltage signal VCC is higher than the second reference signal Vref2, the voltage sampler 21 outputs a high-voltage signal. At this time, the voltage sampler 21 compares the voltage signal VCC with the first reference signal Vref1 again.

Referring to FIG. 5 and FIG. 6, in order to ensure that the reference signal obtained by the voltage sampler 21 can jump from the first reference signal Vref1 to the second reference signal Vref2 during the charging process of the charging capacitor C2, the voltage sampler 21 includes a voltage comparator CMP, a first reference circuit and a second reference circuit arranged at an input terminal of the voltage comparator CMP. The first reference circuit is configured to provide the first reference signal Vref1, and the second reference circuit is configured to provide the second reference signal Vref2. A first conduction element is arranged between the output terminal of the voltage comparator CMP and the first reference circuit, and a second conduction element is arranged between the output terminal of the voltage comparator CMP and the second reference circuit. The conduction conditions of the first conduction element and the second conduction element are opposite, so that the first reference circuit and the second reference circuit cannot be connected to the voltage comparator CMP at the same time.

In an embodiment of the present application, the first conduction element includes a first switch K1 and a third NOT gate NOT3, and the second conduction element includes a second switch K2. The first switch K1 and the second switch K2 have the same structure. The first switch K1 controls whether the first reference circuit is connected to the voltage comparator CMP according to the judgment signal S1 processed by the third NOT gate NOT3. The second switch K2 controls whether the second reference circuit is connected to the voltage comparator CMP according to the judgment signal S1. Under the action of the third NOT gate NOT3, the first reference circuit and the second reference circuit cannot be connected to the voltage comparator CMP at the same time.

In an embodiment of the present application, the first reference circuit or the second reference circuit is connected to the non-inverting input terminal of the voltage comparator CMP, and the inverting input terminal of the voltage comparator CMP is connected to one end of the charging capacitor C2, from which it can be known that the full power signal is a low-level signal, and the recharging signal and the charging signal are high-level signals. The output terminal of the voltage comparator CMP is connected to an input terminal of the second AND gate AMD2, and the other input terminal of the second AND gate AMD2 is connected to the switching power supply chip. When both input terminals of the second AND gate AMD2 are high-level inputs, the charging switch tube Q3 is turned on, and the charging circuit is turned on at this time, and the charging capacitor C2 is charged. When one of the input terminals or both input terminals of the second AND gate AMD2 input a low-level signal, the second AND gate AMD2 outputs a low-level signal, and the charging switch tube Q3 is turned off. At this time, the charging circuit is disconnected and the charging capacitor C2 stops charging.

Referring to FIG. 5 and FIG. 6, a third AND gate AND3 is provided between the voltage comparator CMP and the adjustment control tube Q2. One input terminal of the third AND gate AND3 is connected to the output terminal of the third NOT gate NOT3, the other input terminal of the third AND gate AND3 is connected to the switching power supply chip, and the output terminal of the third AND gate AND3 is coupled to the control electrode of the adjustment control tube Q2. When both input terminals of the third AND gate AND3 are high-level signals, the adjustment control tube Q2 is controlled by the voltage sampler 21, at this time the adjustment control tube Q2 is turned on and the primary circuit is turned on. When one or both input terminals of the third AND gate AND3 are input with a low-level signal, the third AND gate AND3 outputs a low-level signal, and the adjustment control tube Q2 is not controlled by the voltage sampler 21.

Referring to FIG. 5 and FIG. 6, when the charging capacitor C2 is fully charged, the judgment signal S1 output by the voltage comparator CMP is a high-voltage signal, i.e., a low-level signal. At this time, the connection between the second reference circuit and the voltage comparator CMP is disconnected. Under the action of the non-logic device, the first reference circuit is connected to the voltage comparator CMP, and the voltage comparator CMP obtains the first reference signal Vref1. Therefore, the voltage comparator CMP is connected to the first reference circuit from the end of charging of the charging capacitor C2 until the next charging begins. When the charging capacitor C2 needs to be recharged, the voltage comparator CMP is disconnected from the first reference circuit and connected to the second reference circuit until the charging of the charging capacitor C2 is completed. When the control signal SW jumps from a low level to a high level and the charging capacitor C2 is in a state where it needs to be recharged, the voltage comparator CMP outputs a high-level signal, the second switch K2 is closed to control the second reference circuit to be connected to the voltage comparator CMP, the first AND logic device outputs a high-level signal, the charging switch tube Q3 is turned on, and the charging capacitor C2 is charged, so the voltage of the charging capacitor C2 gradually increases. When the voltage signal VCC obtained by the voltage comparator CMP is higher than the second reference signal Vref2, the voltage comparator CMP outputs a low-level signal, and the second switch K2 controls the second reference circuit to be disconnected from the voltage comparator CMP, and the first switch K1 controls the first reference circuit to be connected to the voltage comparator CMP under the action of the third NOT gate NOT3.

Referring to FIG. 5 and FIG. 6, in order to ensure that the primary coil N1 stores energy normally and prevent the charging capacitor C2 from not being able to reach the second reference signal Vref2, which causes the primary coil N1 to not store energy normally, the charging control unit 2 further includes an OR logic device OR. The two input terminals of the OR logic device OR are respectively connected to the output terminal of the third AND gate AND3 and the output terminal of the delay device TD, and the output terminal of the OR logic device OR is coupled to the control electrode of the adjustment control tube Q2. Therefore, in an embodiment of the present application, the signal outputted from the output terminal of the OR logic device OR is the conduction switch signal SQ. Under the action of the OR logic device OR, when either the delay device TD or the third AND gate AND3 outputs a high level, the adjustment control tube Q2 is turned on. When the adjustment control tube Q2 is turned on, the primary circuit is turned on to ensure that the primary coil N1 can store energy normally.

The power supply principle of a self-powered circuit of a switching power supply in an embodiment of the present application is as follows: when the control signal SW output by the switching power supply chip is a high-level signal, the delay device TD starts timing, and within the preset time Tdly of the delay device TD, the delay signal St output by the delay device TD is a low-level signal, so a low-level signal is input to the end of the OR logic device OR connected to the delay device TD. At this time, if the voltage comparator CMP outputs a low-level signal, it means that the charging capacitor C2 has sufficient power and does not need to be recharged. At this time, the charging control unit 2 outputs a high-level signal, adjustment control tube Q2 is turned on, and the primary coil N1 stores energy.

If the voltage comparator CMP outputs a high-level signal, it means that the charging capacitor C2 is insufficient and needs to be recharged. At this time, the second AND gate AMD2 outputs a high-level signal, the charging switch tube Q3 is turned on, and the charging capacitor C2 starts to charge. The voltage sampler 21 samples the voltage of the charging capacitor C2 in real time and outputs a voltage signal VCC to the voltage comparator CMP. Within the preset time Tdly, when the voltage signal VCC received by the voltage comparator CMP is not greater than the second reference signal Vref2, the voltage comparator CMP outputs a high-level signal, the second AND gate AMD2 maintains a high-level output, the charging switch tube Q3 remains turned on, and the charging circuit is turned on to charge the charging capacitor C2. The input terminal of the third AND gate AND3 connected to the voltage sampler 21 is a low-level input, so the third AND gate AND3 outputs a low-level signal, the OR logic device OR outputs a low-level signal, the enable pin En of the operational amplifier AMP inputs a high-level signal, and the operational amplifier AMP works normally. The control electrode of the adjustment control tube Q2 is controlled by the voltage limiting control unit 1, when the charging voltage VA of the charging capacitor C2 is lower than the preset voltage value Vref, the voltage analog signal Samp output by the operational amplifier AMP is a low level, and the adjustment control tube Q2 does not pull down the charging voltage VA. When the charging voltage VA of the charging capacitor C2 is greater than the preset voltage value Vref, the voltage analog signal Samp output by the operational amplifier AMP is greater than the turn-on value of the adjustment control tube Q2, the adjustment control tube Q2 is in an incompletely turned-on state under the action of the voltage analog signal Samp, and the adjustment control tube Q2 pulls down the charging voltage VA, so that the charging voltage VA of the charging capacitor C2 is not greater than the preset voltage value Vref.

Within the preset time Tdly, if the voltage signal VCC received by the voltage comparator CMP is greater than the second reference signal Vref2, it means that the charging capacitor C2 has completed charging. At this time, the voltage comparator CMP outputs a low-level signal, the second AND gate AMD2 outputs a low-level signal, the charging switch tube Q3 is turned off, and the charging capacitor C2 stops charging. At the same time, the first reference circuit is connected to the voltage comparator CMP, the voltage signal VCC is compared with the first reference signal Vref1, and the third AND gate AND3 outputs a high-level signal, so the OR logic device OR outputs a high-level signal, the enable pin En of the operational amplifier AMP inputs a low-level signal, the output of the operational amplifier AMP is in a suspended state, the control electrode of the adjustment control tube Q2 is controlled to be turned on by the charging control unit 2, and the source of the withstand voltage switch tube Q1 is grounded. At this time, the charging capacitor C2 stops charging to ensure that the primary coil N1 can store energy normally.

When the timing duration of the delay device TD reaches the preset time Tdly, the delay signal St output by the delay device TD is a high-level signal, and the voltage signal VCC received by the voltage comparator CMP is still less than the second reference signal Vref2. At this time, the input terminal of the OR logic device OR connected to the delay device TD receives a high-level signal, the OR logic device OR outputs a high-level signal, a low-level signal is input to the enable pin En of the operational amplifier AMP, the output of the operational amplifier AMP is in a suspended state, the control electrode of the adjustment control tube Q2 is controlled to be turned on by the charging control unit 2, and the source of the withstand voltage switch tube Q1 is grounded. At this time, the charging capacitor C2 stops charging to ensure that the primary coil N1 can store energy normally.

When the control signal SW output by the switching power supply chip is at a low level, the second AND logic device outputs a low-level signal, and the charging switch tube Q3 is turned off. The third AND logic device outputs a low-level signal, the OR logic device OR outputs a low-level signal, and the adjustment control tube Q2 is turned off. At this time, the primary circuit is disconnected, and the secondary coil N2 supplies power to the load.

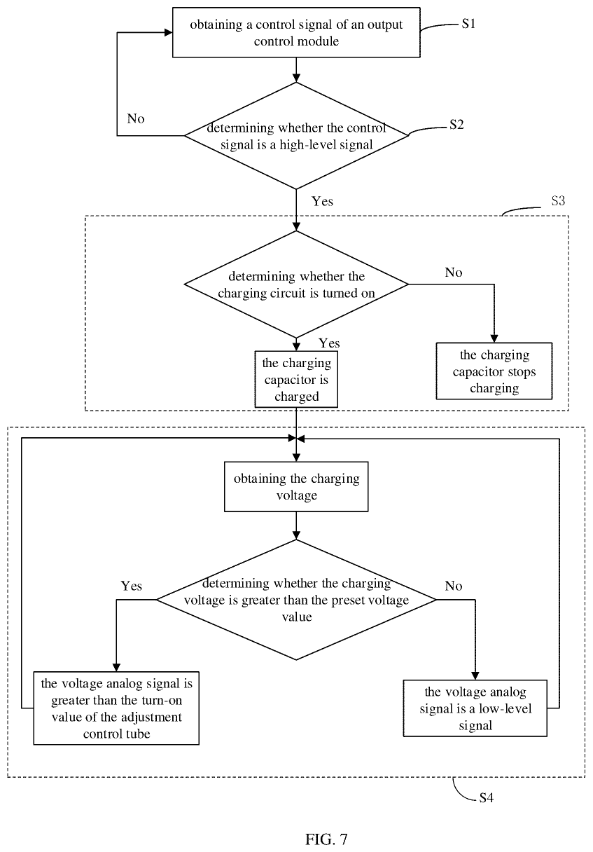

An embodiment of the present application also discloses a self-powering method of a switching power supply. Referring to FIG. 7, the self-powering method includes the following steps:

S1, obtaining a control signal SW of a switching power supply chip.

Specifically, the control signal SW output by the switching power supply chip includes two signals, a high level and a low level. The switching power supply chip is connected to the control electrode of the charging switch tube Q3. Whether the charging switch tube Q3 is turned on is controlled by the control signal SW output by the switching power supply chip. When the control signal SW is at a low level, the charging switch tube Q3 is turned off. When the control signal SW is at a high level, the charging switch tube Q3 may be turned on.

S2, determining whether the control signal SW is a high-level signal; if so, execute the following steps; if not, reacquire the control signal SW.

S3, determining whether the charging circuit is turned on; if so, the charging capacitor C2 is charged and the following steps are performed; if not, the charging capacitor C2 stops charging.

Specifically, the control signal SW has two states: high level and low level. When the control signal SW is low level, the primary coil N1 will not be turned on, so the charging capacitor C2 cannot be charged. When the control signal SW is high level, the charging capacitor exists in two states: charging and not charging according to the charging requirements.

That is, when the control signal SW output by the switching power supply chip is at a high level, the charging circuit may be turned on or off. When the charging circuit is turned on, the charging capacitor C2 is charged. When the charging circuit is turned off, the charging capacitor C2 stops charging.

S4, obtaining the charging voltage VA, and determining whether the charging voltage VA is greater than the preset voltage value Vref; if so, the voltage analog signal Samp is greater than the turn-on value of the adjustment control tube Q2 to pull down the charging voltage VA, if not, the voltage analog signal Samp is a low-level signal.

Specifically, in order to ensure that the charging capacitor C2 is charged under a low voltage state to reduce the charging loss and reduce the area of the self-powered circuit device, the operational amplifier AMP and the adjustment control tube Q2 form a feedback loop. A preset voltage value Vref is input to one input terminal of the operational amplifier AMP, and the other input terminal of the operational amplifier AMP detects and obtains the charging voltage VA in real time. The operational amplifier AMP compares the charging voltage VA with the preset voltage value Vref and outputs a voltage analog signal Samp. When the charging voltage VA is less than or equal to the preset voltage value Vref, the voltage analog signal Samp output by the operational amplifier AMP is a low-level signal, and the adjustment control tube Q2 remains cut off at this time. When the charging voltage VA is greater than the preset voltage value Vref, the voltage analog signal Samp output by the operational amplifier AMP is greater than the turn-on value of the adjustment control tube Q2, and the adjustment control tube Q2 is in an incompletely turned-on state under the action of the voltage analog signal Samp, and the adjustment control tube Q2 pulls down the charging voltage VA so that the charging voltage VA of the charging capacitor C2 is not greater than the preset voltage value Vref. During the charging process of the charging capacitor C2, the operational amplifier AMP continuously and repeatedly obtains the charging voltage VA and compares it with the preset voltage value Vref.

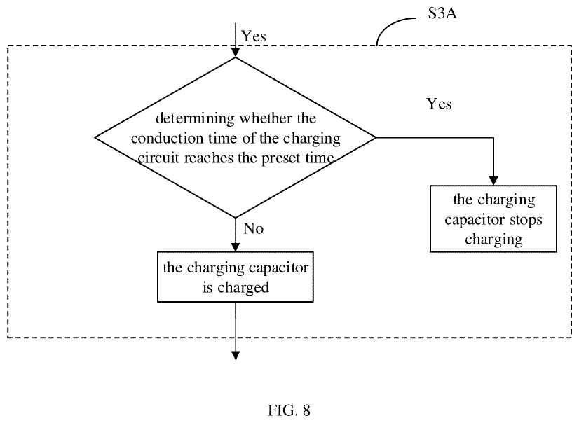

In an embodiment, referring to FIG. 7 and FIG. 8, determining whether the charging circuit is turned on specifically includes the following steps:

S3A, determining whether the conduction time of the charging circuit reaches the preset time Tdly; if not, the charging circuit is turned on; if so, the charging circuit is turned off.

Specifically, in an embodiment of the present application, the charging requirement of the charging capacitor C2 is the charging time, and the delay device TD is configured to time the time when the control signal SW is at a high level, and the preset time Tdly is preset. The delay device TD is triggered at a high level, that is, when the control signal SW is at a high level, the delay device TD starts to start timing. When the control signal SW is at a high level, the charging switch tube Q3 is turned on first, and the charging circuit is turned on to charge the charging capacitor C2. At this time, the delay device TD counts the conduction time of the charging circuit. When the timing time of the delay device TD reaches the preset time Tdly, the adjustment control tube is turned on, the source of the withstand voltage switch tube Q1 is grounded, the charging circuit is disconnected, the charging capacitor C2 stops charging, the primary circuit is turned on, and the primary coil N1 starts to store energy until the control signal SW jumps from a high level to a low level, the charging circuit and the primary circuit are both disconnected, and the secondary coil N2 supplies power to the load.

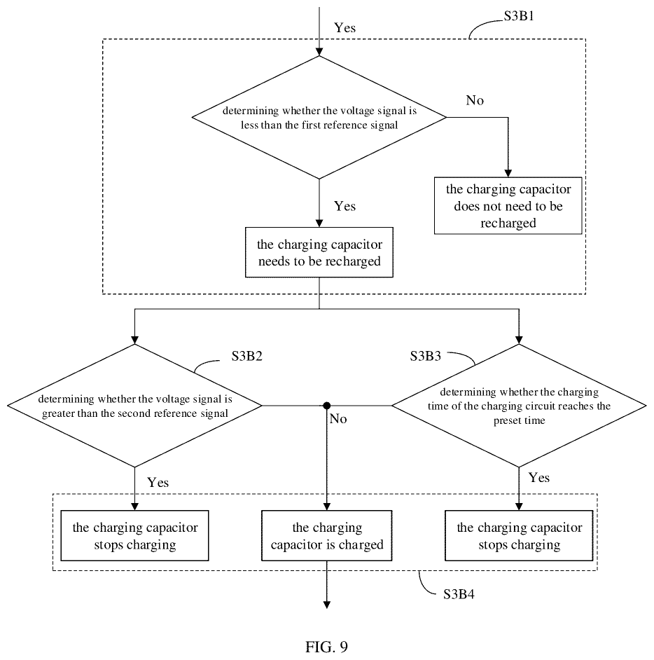

In another embodiment, referring to FIG. 7 and FIG. 9, determining whether the charging circuit is turned on specifically includes the following steps:

S3B1, determining whether the voltage signal VCC of the charging capacitor C2 is less than the first reference signal Vref1, if so, the charging capacitor C2 needs to be recharged and the following steps are performed, if not, the charging capacitor C2 does not need to be recharged.

S3B2, determining whether the conduction time of the charging circuit reaches the preset time Tdly;

S3B3, determining whether the voltage signal VCC of the charging capacitor C2 is greater than the second reference signal Vref2;

S3B4, if the above judgment results are all no, the charging circuit is turned on; if any judgment result is yes, the charging circuit is turned off.

Specifically, in an embodiment of the present application, in order to prevent the charging capacitor C2 from being charged when the charging capacitor C2 has sufficient power, the voltage sampler 21 detects the voltage signal VCC of the charging capacitor C2 and compares the voltage signal VCC with its preset reference signal. The reference signal includes a first reference signal Vref1 and a second reference signal Vref2. The first reference signal Vref1 is less than the second reference signal Vref2.

Before a switching cycle arrives, first determine whether the charging capacitor C2 needs to be recharged, that is, the voltage comparator CMP compares the voltage signal VCC of the charging capacitor C2 with the first reference signal Vref1. If the voltage signal VCC is greater than the first reference signal Vref1, it means that the charging capacitor C2 does not need to be recharged. If the voltage signal VCC is less than the first reference signal Vref1, it means that the charging capacitor C2 needs to be recharged. If the charging capacitor C2 does not need to be charged, the charging circuit will always remain disconnected when the control signal SW is at a high level. If the charging capacitor C2 needs to be charged, the charging circuit will be turned on to charge the charging capacitor C2 when the control signal SW is at a high level. When the charging capacitor C2 meets the charging requirements, the charging circuit is disconnected, the charging capacitor C2 stops charging, and the primary coil N1 stores energy.

In an embodiment of the present application, the charging requirement of the charging capacitor C2 is the voltage signal VCC or the charging time. When the voltage signal VCC of the charging capacitor C2 reaches the requirement or the charging time reaches the requirement, it means that the charging of the charging capacitor C2 is completed, and the charging circuit is disconnected. At this time, the primary coil N1 continues to store energy. The delay device TD is high-level triggered, is configured to time the duration of the control signal SW being high level, and is preset with a preset time Tdly.

When the voltage signal VCC of the charging capacitor C2 is less than the first reference signal Vref1, the voltage sampler 21 disconnects the first reference circuit from the voltage comparator CMP under the action of the third NOT gate NOT3, and connects the second reference circuit to the voltage comparator CMP. At this time, the voltage comparator CMP compares the voltage signal VCC with the second reference signal Vref2. When the control signal SW output by the switching power supply chip is at a high level, the charging switch tube Q3 is turned on, the charging capacitor C2 starts to charge, and the delay device TD starts to start timing.

Within the preset time Tdly, if the voltage signal VCC is greater than the second reference signal Vref2, it means that the charging capacitor C2 is fully charged. At this time, the voltage sampler 21 compares the voltage signal VCC with the first reference signal Vref1 again, the charging switch tube Q3 is turned off, the charging circuit is disconnected, the charging capacitor C2 stops charging, the adjustment control tube Q2 is turned on, the primary circuit is turned on, and the primary coil N1 stores energy.

If the timing duration of the delay device TD reaches the preset time Tdly, and the voltage signal VCC of the charging capacitor C2 is still less than the second reference signal Vref2, the delay device TD outputs a high-level signal, so that the enable pin En of the operational amplifier AMP inputs a low-level signal, and the output of the operational amplifier AMP is in a suspended state. The control electrode of the adjustment control tube Q2 is controlled to be turned on by the charging control unit 2, and the source of the withstand voltage switch tube Q1 is grounded. At this time, the charging capacitor C2 stops charging to ensure that the primary coil N1 can store energy normally.

An embodiment of the present application also discloses a self-powered chip of a switching power supply. The self-powered chip integrates the self-powered circuit disclosed in the above embodiments, including a charging capacitor C2, a withstand voltage switch tube Q1, a charging switch tube Q3, an adjustment control tube Q2, a voltage limiting control unit 1 and a charging control unit 2, so that the charging capacitor C2 takes power from the primary coil N1, and adaptively supplements the charging capacitor C2 with a small voltage during the switching cycle. The power supply chip is suitable for a flyback switching power supply, using a depletion-type gallium nitride transistor as a withstand voltage switch tube Q1, and taking power from the source end by using its working characteristics, ensuring that the self-powered chip only works in a low-voltage state, reducing the complexity of the chip, and reducing the withstand voltage requirements of the internal components of the chip. That is, the charging switch tube Q3, the adjustment control tube Q2 and the unidirectional conduction tube D2 can be designed with components with a lower withstand voltage, saving the layout area, thereby reducing the final chip area, improving efficiency and reducing costs. The withstand voltage switch tube Q1 and the charging capacitor C2 can not only be integrated in the self-powered chip, but also be independent of the self-powered chip and set separately. Similarly, the output control module can also be integrated in the same chip with the self-powered circuit.

The above are all embodiments of the present application, and the protection scope of the present application is not limited thereto. Therefore, any equivalent changes made according to the structure, shape, and principle of the present application should be included in the protection scope of the present application.

What is claimed is:

1. A self-powered circuit of a flyback switching power supply, applied to the flyback switching power supply, comprising:
a charging capacitor configured to draw power from a primary coil and supply power to a switching power supply chip;
a withstand voltage switch tube connected between the primary coil and the charging capacitor, and configured to obtain a power supply voltage of the primary coil, and output a charging voltage for charging the charging capacitor;
a charging switch tube, connected between the withstand voltage switch tube and the charging capacitor, provided with a control electrode coupled to the switching power supply chip, and configured to control whether to charge the charging capacitor;
an adjustment control tube, connected between the withstand voltage switch tube and ground, connected in parallel with the charging switch tube and the charging capacitor, and configured to limit the charging voltage of the charging capacitor;
a voltage limiting control unit, provided with an input terminal coupled to the withstand voltage switch tube and configured to sample the charging voltage, and an output terminal coupled to the control electrode of the adjustment control tube and configured to control conduction state of the adjustment control tube according to the charging voltage;
a charging control unit, preset with a charging requirement and configured to output a conduction switch signal for controlling the adjustment control tube to be turned on or off; and
an inverter, coupled to the voltage limiting control unit and the charging control unit, and configured to obtain the conduction switch signal, and control the voltage limiting control unit or the charging control unit to be connected to the adjustment control tube according to the conduction switch signal.

2. The self-powered circuit of the flyback switching power supply according to claim 1, wherein:
a unidirectional conduction tube and a protection resistor are connected in series between the charging capacitor and the charging switch tube;
the unidirectional conduction tube is configured to realize unidirectional conduction of current from the charging switch tube to the charging capacitor; and
the protection resistor is configured to limit charging current of the charging capacitor.

3. The self-powered circuit of the flyback switching power supply according to claim 1, wherein the voltage limiting control unit comprises:
a preset reference circuit configured to provide a preset voltage value, and
an operational amplifier, configured to obtain the charging voltage and compare the charging voltage with the preset voltage value to output a voltage analog signal,
wherein an enable pin of the operational amplifier is connected to the inverter, and the inverter is configured to control whether the operational amplifier works normally; and
an output terminal of the operational amplifier is connected to the adjustment control tube, and the voltage analog signal is configured to control whether the adjustment control tube is turned on.

4. The self-powered circuit of the flyback switching power supply according to claim 3, wherein the inverter comprises a first AND gate, a first NOT gate, a second NOT gate and an output switch tube;
an input terminal of the first NOT gate is coupled to an output terminal of the charging control unit, and is configured to obtain the conduction switch signal;
an input terminal of the first AND gate is connected to the switching power supply chip and an output terminal of the first NOT gate respectively, and an output terminal of the first AND gate is connected to the enable pin of the operational amplifier and is configured to control whether the operational amplifier works normally;
an input terminal of the second NOT gate is connected to the output terminal of the first AND gate, and an output terminal of the second NOT gate is connected to the output switch tube and is configured to control the output switch tube to be turned on or off; and
the output switch tube is configured to control whether the charging control unit is connected to the adjustment control tube.

5. The self-powered circuit of the flyback switching power supply according to claim 3, wherein the charging control unit comprises a delay device with a preset time, the delay device is coupled between the switching power supply chip and the adjustment control tube, and is configured to delay outputting a control signal.

6. The self-powered circuit of the flyback switching power supply according to claim 5, wherein the charging control unit further comprises:
a voltage sampler configured to obtain a voltage signal of the charging capacitor and output a judgment signal for controlling the adjustment control tube to be turned on or off; and
a second AND gate, provided with an input terminal connected to the voltage sampler and the switching power supply chip respectively, and an output terminal connected to the control electrode of the charging switch tube, and configured to obtain the judgment signal and the control signal, and control whether the charging switch tube is turned on according to the judgment signal and the control signal.

7. The self-powered circuit of the flyback switching power supply according to claim 6, wherein:
the voltage sampler comprises a voltage comparator, a first reference circuit and a second reference circuit provided at an input terminal of the voltage comparator;
the first reference circuit is configured to provide a first reference signal, the second reference circuit is configured to provide a second reference signal, and the second reference signal is greater than the first reference signal; and
a first conduction element is provided between an output terminal of the voltage comparator and the first reference circuit, a second conduction element is provided between the output terminal of the voltage comparator and the second reference circuit, and the first conduction element and the second conduction element have opposite conduction conditions.

8. The self-powered circuit of the flyback switching power supply according to claim 6, wherein the charging control unit further comprises:
a third AND gate, connected between the voltage sampler and the adjustment control tube, and provided with an input terminal respectively connected to the voltage sampler and the switching power supply chip, and an output terminal coupled to the adjustment control tube; and
an OR logic device, provided with an input terminal respectively connected to the delay device and the third AND gate, and an output terminal connected to the inverter.

9. A switching power supply applying the self-powered circuit of the flyback switching power supply according to claim 1, comprising a transformer, an output control module configured to adjust a load regulation rate, and a self-powered circuit configured to supply power to the output control module,
wherein the transformer comprises a primary coil and a secondary coil;
the output control module comprises a switching power supply chip configured to outputting a control signal; and
the self-powered circuit comprises a charging capacitor configured to power, a charging switch tube and a charging control unit configured to control whether the charging capacitor is charged, and a voltage limiting control unit configured to limit charging voltage of the charging capacitor.

10. A self-powering method based on the self-powering circuit of the flyback switching power supply according to claim 1, comprising:
acquiring a control signal of a switching power supply chip;
determining whether the control signal is a high-level signal; in response to that the control signal is the high-level signal, performing the following steps; in response to that the control signal is not the high-level signal, reacquiring the control signal;
determining whether a charging circuit is turned on; in response to that the charging circuit is turned on, charging a charging capacitor and performing the following steps; in response to that the charging circuit is not turned on, stopping charging the charging capacitor; and
obtaining a charging voltage and determining whether the charging voltage is greater than a preset voltage value; in response to that the charging voltage is greater than the preset voltage value, making a voltage analog signal greater than the adjustment control tube turn-on value to pull down the charging voltage; in response to that the charging voltage is not greater than the preset voltage value, making the voltage analog signal a low-level signal.

11. The self-powering method according to claim 10, wherein the determining whether the charging circuit is turned on comprises:
determining whether a conduction time of the charging circuit reaches a preset time;
in response to that the conduction time of the charging circuit does not reach the preset time, turning on the charging circuit; or
in response to that the conduction time of the charging circuit reaches the preset time, turning off the charging circuit.

12. The self-powering method according to claim 10, wherein the determining whether the charging circuit is turned on comprises:
determining whether a voltage signal of the charging capacitor is less than a first reference signal; in response to that the voltage signal of the charging capacitor is less than the first reference signal, recharging the charging capacitor and performing the following steps; in response to that the voltage signal of the charging capacitor is not less than the first reference signal, do not recharging the charging capacitor;
determining whether the conduction time of the charging circuit reaches the preset time;
determining whether the voltage signal of the charging capacitor is greater than a second reference signal; and
in response to that the conduction time of the charging circuit does not reach the preset time and the voltage signal of the charging capacitor is less than or equal to the second reference signal, turning on the charging circuit; in response to that the conduction time of the charging circuit reaches the preset time or the voltage signal of the charging capacitor is greater than a second reference signal, turning off the charging circuit.
